(19) United States
(12) Patent Application Publication
(10) Pub. No.: US 2010/0041567 A1
(43) Pub. Date: Feb. 18, 2010

(54) Antibody-Based Protein Microarray to Detect Long-Term Stress In Animal Tissues

(76) Inventors: David Janz, Saskatoon (CA); Marc Cattet, Saskatoon (CA); Ruth Carlson, Saskatoon (CA)

Correspondence Address: ADE & COMPANY INC., 2157 Henderson Highway, WINNIPEG, MB, R2G1P9, CA

(21) Appl. No.: 12/507,909

(22) Filed: Jul. 23, 2009

Related U.S. Application Data
(60) Provisional application No. 61/088,390, filed on Aug. 13, 2008.

(51) Int. Cl. C40B 30/04; C40B 40/10

(52) U.S. Cl. 506/9; 506/18

(57) ABSTRACT

A method for determining ‘stress profiles’ of wildlife by measuring the expression of a plurality of stress-activated proteins is herein described.

### PRIOR APPLICATION INFORMATION

This application claims the benefit of U.S. Provisional Patent Application 61/088,390, filed Aug. 13, 2008.

### BACKGROUND OF THE INVENTION

Although populations are usually a major focus of wildlife monitoring and conservation strategies, the responses of individual animals to human alteration of the environment is what contributes to poor performance of resident wildlife populations (Wikelski and Cooke, 2006, Trends in Ecology and Evolution 21: 38-46). Wild animals are exposed to many ‘stressors’ throughout their life but often cope successfully through a suite of psychological and behavioral mechanisms, collectively known as the ‘stress response’ (Reeder and Kramer, 2005, Journal of Mammalogy 86: 225-235). However, the duration of a stressor is important. Whereas short-term stress encountered during the normal activities and experiences of daily life rarely pose a threat to healthy animals, long-term stress can exceed an animal's ability to cope (Moberg and Mench in The Biology of Animal Stress, CABI Publishing: New York, 2000).

Stresses can be categorized as ‘acute’, that is, a stress that is experienced for 1-4 hours; ‘chronic’, that is, a stress that persists for weeks, months or years; and ‘repeated’, that is, a stress that is intermittent over hours, days, weeks, months or years.

When stressed for weeks to months (i.e., long-term stress), an animal loses its capacity to sustain normal biological function (i.e., growth, reproduction, immunity, activity) and gradually develops signs of impaired health (termed ‘distress’) including reduced growth, impotency, infection and sometimes premature death (Moberg and Mench in The Biology of Animal Stress, CABI Publishing: New York, 2000).

Previously, a 2-D gel-based procedure was used to separate proteins from a mixture of biochemical compounds based on characteristics of mass and charge. The gel-separated protein was then isolated and identified by mass spectrometry followed by a comparison of its mass spectrometry characteristics with those documented for a library of known proteins. The inventors used a 2-D gel-based procedure as a technique to potentially identify stress-activated proteins that might be unique to bears. However, such a 2-D gel-based technique would be too labour-intensive, time consuming, and expensive to identify a large number of stress-related proteins.

There is a recognized need to develop sensitive, reliable and rapid techniques to evaluate long-term stress in wildlife, essentially to serve as ‘early-warning systems’ to forecast adverse effects in individuals before they manifest in populations (Clark et al. 2001, Science 293: 657-60).

### SUMMARY OF THE INVENTION

According to a first aspect of the invention, there is provided a chip comprising antibodies raised against ACTH, glucocorticoid receptor, CRHR-1/2, POMC, prolactin, arginine vasopressin receptor V1a, superoxide dismutase 1, superoxide dismutase 2, peroxiredoxin-3, CCR5, iNOS, eNOS, heme oxygenase-2, cyclooxygenase-2, HSP27, HSP40, HSP60, HSP70, HSP70i, HSP90, HSP110, GRP78/BIP, AIF, annexin II, annexin IV, caspase 1, caspase 2, caspase 3, caspase 6, cytokeratin, E-cadherin and GAPDH, with each respective antibody being printed on the chip at a specific discrete location on the chip.

According to a second aspect of the invention, there is provided a method for analysing stress levels in an animal comprising:
providing a sample from an animal suspected of being under stress; and
determining a stress profile for said animal by determining expression of one or more stress-related proteins.

### BRIEF DESCRIPTION OF THE DRAWINGS

FIG. 1 is schematic diagram showing one embodiment of the invention.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

For wildlife, there is urgent need for rapid assessment of long-term stress. Specifically, populations with slow reproduction are at significant risk to the effects of increasing habitat alteration effects. That is, because the time lapse between human alteration of the environment and reduction in wildlife population performance can take many years (Findlay and Bourdages, 2000, Conservation Biology 14: 86-94), broadening the focus of wildlife monitoring and conservation strategies to include assessment of long-term stress and biological function in individual animals provides opportunity to alleviate environmental stressors before population performance is affected.

Stress factors can be divided into multiple groups, for example, psychological stress factors and environmental stress factors. Examples of environmental stress factors include but are by no means limited to pathogenic microbes (e.g., bacteria, fungi, viruses, etc.), extreme weather, UV light, ozone, toxic agents, sources of physical injury (e.g., gunshot, motorized vehicles, etc.), free radicals, and allergens.

Categories of stress proteins include but are by no means limited to cellular detoxification proteins, oxidative stress repair proteins, neuroendocrine regulation proteins, cell growth control proteins, apoptosis proteins and immune signalling proteins. Accordingly, these proteins may also be grouped by category of stress.

Examples of specific stress proteins include but are by no means limited to adrenocorticotropic hormone (ACTH), apoptosis inducing factor (AIF), annexin II, annexin IV, arginine vasopressin receptor V1a, caspase 1, caspase 2, caspase 3, caspase 6, CC-motif chemokine receptor 5 (CCR5), cyclooxygenase-2, corticotropin releasing hormone receptor 1/2 (CRHR-1/2), cytokeratin, E-cadherin, glyceraldehyde-3-phosphate dehydrogenase (GAPDH), glucocorticoid receptor, glucose regulated protein (GRP78/BIP), heme oxygenase-2, heat shock protein 27 (HSP27), heat shock protein 40 (HSP40), heat shock protein 60 (HSP60), heat shock protein 70 (HSP70), heat shock protein 70 inducible (HSP70i), heat shock protein 90 (HSP90), heat shock protein 110 (HSP110), inducible nitric oxide synthase (iNOS), endothelial nitric oxide synthase (eNOS), pro-opiomelanocortin (POMC), peroxiredoxin (PRDX3), prolactin, superoxide dismutase-1 and superoxide dismutase-2. It is important to note that the above list is by no means exhaustive and is intended for illustrative purposes. It is of note that other stress proteins, that is, proteins whose expression levels rise or fall in accordance with encountering environmental and/or physiological stressors, are well known to those of skill in the art.

These proteins may be grouped into categories of stress: hypothalamic-pituitary-adrenal axis (ACTH, glucocorticoid receptor, CRHR-1/2, POMC, prolactin, arginine vasopressin receptor V1a), oxidative stress and inflammation (superoxide dismutase 1, superoxide dismutase 2, peroxiredoxin-3, CCR5, iNOS, eNOS, heme oxygenase-2, cyclooxygenase-2), cellular stress and proteotoxicity (HSP27, HSP40, HSP60, HSP70, HSP70i, HSP90, HSP110, GRP78/BIP) and apoptosis and mitosis (AIF, annexin II, annexin IV, caspase 1, caspase 2, caspase 3, caspase 6, cytokeratin, E-cadherin, GAPDH).

In an embodiment of the invention, there is provided an antibody array comprising a plurality of antibodies, each respective one of the antibodies being raised against a different stress protein. Preferably, each respective antibody is mounted to a substrate or support at a discrete location. As will be appreciated by one of skill in the art, the singular form ‘antibody’ is used above but it is to be understood that more than one copy of a given antibody may be mounted or crosslinked to the substrate or support at a given discrete location. It is also important to note that while reference is made to the antibodies being raised or reactive or directed against different stress proteins, it is not a strict requirement of the invention that all locations on the array be directed against a different stress protein. Specifically, in some embodiments or when assaying certain samples, it may be advantageous to have the same antibody at two or more locations on the support. Similarly, in some embodiments or when assaying certain samples, it may be advantageous to crosslink or ‘print’ two different antibodies binding the same stress protein at two different locations on the support or ‘chip’.

In a preferred embodiment, the array comprises a ‘chip’ comprising antibodies raised against ACTH, glucocorticoid receptor, CRHR-1/2, POMC, prolactin, arginine vasopressin receptor V1a, superoxide dismutase 1, superoxide dismutase 2, peroxiredoxin-3, CCR5, iNOS, eNOS, heme oxygenase-2, cyclooxygenase-2, HSP27, HSP40, HSP60, HSP70, HSP70i, HSP90, HSP110, GRP78/BIP, AIF, annexin II, annexin IV, caspase 1, caspase 2, caspase 3, caspase 6, cytokeratin, E-cadherin and GAPDH, with each respective antibody being printed on the chip at a specific discrete location on the chip.

As will be apparent to one of skill in the art, the respective antibodies may be printed onto the chip in an ordered manner such that related antibodies, that is, for example, antibodies against functionally related proteins or providing related information, for example, on oxidative or cellular stresses, are grouped together. As will be appreciated by one of skill in the art, such ordering may help in interpretation of results but is not necessarily a critical feature of the invention.

As will be appreciated by one of skill in the art, the above list describes one embodiment of the invention. It is however important to note that in other embodiments of the invention, combinations of the above listed proteins may be used. That is, while in a preferred embodiment, the array comprises antibodies directed against each of the individual proteins, in some embodiments, subsets of the antibodies may be used. In addition, it is important to note that the above list is intended for illustrative purposes and is not exhaustive. Accordingly, antibodies against other evolutionarily conserved proteins which are related to the stress response may be incorporated into the array.

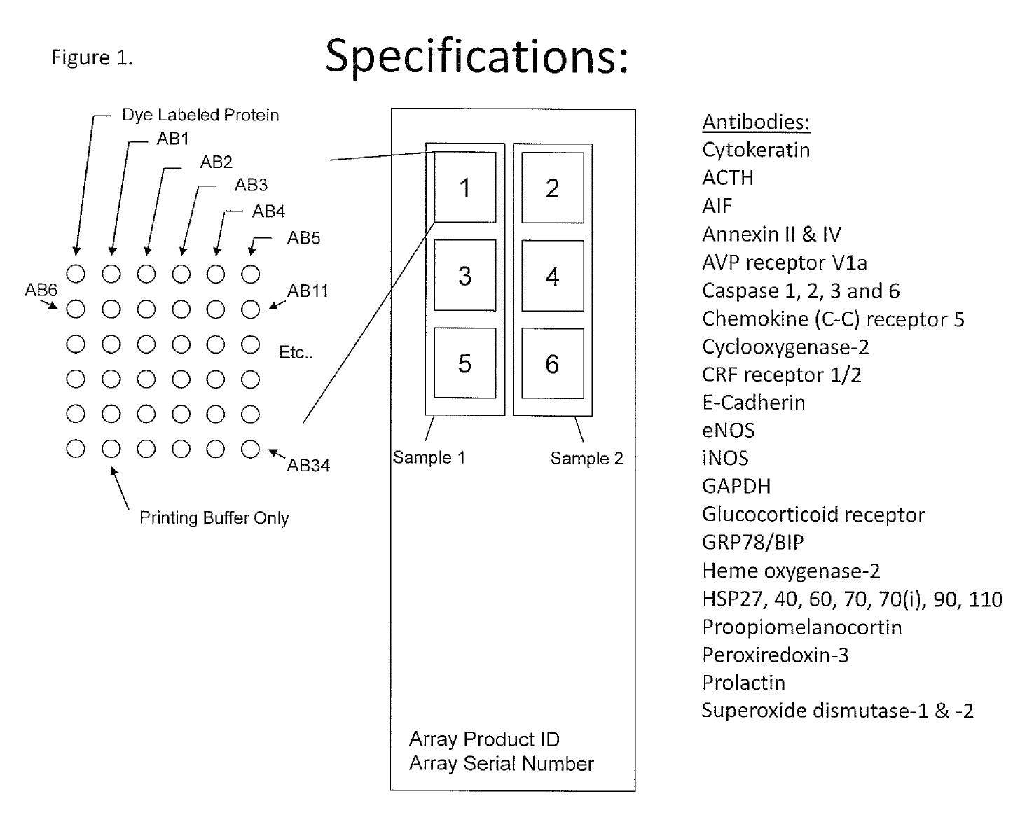

In a preferred embodiment, there may be loaded onto a slide such that there are two identical arrays per slide with the arrays loaded in triplicate for each sample as shown in FIG. 1.

It is important to note that the proteins described above are highly conserved evolutionarily and accordingly antibodies against a specific stress protein from one animal species is likely to cross-react with the corresponding protein from another animal species. Thus, while in the exemplary examples, the samples analyzed are from grizzly bears, samples from animals including other mammals, birds, fishes, reptiles, and amphibians may also be analyzed using the array described herein. Indeed, although the array was initially developed specifically for grizzly bears, subsequent testing in other animal species has shown the array to perform equally well in samples from polar bear, ringed seal, moose and rat.

In use, the array allows clustering and ordination analysis of the protein expression patterns which can then be compared with other data collected on the bears.

In an embodiment of the invention, there is provided a method for analysing stress levels in an animal comprising:
providing a sample from an animal suspected of being under stress; and
determining a stress profile for said animal by determining expression of one or more stress-related proteins.

As discussed above, the animal under stress may be an animal that is subjected or is suspected of being subjected to one or more stressors as defined above.

In the embodiments described above, the stress profile may be determined by analyzing the expression of one or more stress-related proteins as defined herein.

The stress profile may be determined using a chip comprising one or more antibodies against said stress-related proteins.

The stress-related proteins may be selected from the group consisting of: ACTH, glucocorticoid receptor, CRHR-1/2, POMC, prolactin, arginine vasopressin receptor V1a, superoxide dismutase 1, superoxide dismutase 2, peroxiredoxin-3, CCR5, iNOS, eNOS, heme oxygenase-2, cyclooxygenase-2, HSP27, HSP40, HSP60, HSP70, HSP70i, HSP90, HSP110, GRP78/BIP, AIF, annexin II, annexin IV, caspase 1, caspase 2, caspase 3, caspase 6, cytokeratin, E-cadherin, GAPDH and mixtures thereof.

In a preferred embodiment, the individual samples are labelled with a first reporter, for example, a first fluorescent dye while standards are labelled with a second reporter, for example, a second fluorescent dye. The standards may be pooled reference samples.

While any type of reporter compound known in the art may be used, in one embodiment, fluorescent dyes Cy3 and Cy5 are used. As will be known by those of skill in the art, Cy3 absorbs at 550 nm and emits at 570 nm while Cy5 absorbs at 650 nm and emits at 670 nm.

In one embodiment, skin or muscle samples are collected from the animal of interest, for example, a grizzly bear. The samples are then labelled with the reporter as discussed above. The labelled sample is then applied to the array under conditions suitable for protein-antibody and/or peptide-antibody interaction. Following a suitable incubation period, unbound material is washed away or otherwise removed and the material bound to each of the discrete locations on the chip is measured using the reporter and means known in the art.

Accordingly, the array can be used to evaluate long-term stress in wildlife as discussed above, thereby providing a method for determining the current stress state of animals within a population which allows for quicker intervention than following population dynamics over time. Further, the array can be used as a wildlife conservation tool to provide baseline background data on wild populations and to evaluate the efficacy of conservation actions.

In other embodiments, the array may be used to monitor stress in domestic animals, for example, in livestock and poultry. As discussed above and as will be appreciated by one of skill in the art, stressors can have a negative impact on performance of livestock animals.

As will be appreciated by one of skill in the art, a stress profile as discussed above can be determined by a number of means. For example, the pattern of expression visible on the chip may be used directly as a stress profile or the intensity of signals at each location may be quantified. Other similar methods for determining a stress profile will be readily apparent to one of skill in the art.

While the preferred embodiments of the invention have been described above, it will be recognized and understood that various modifications may be made therein, and the appended claims are intended to cover all such modifications which may fall within the spirit and scope of the invention.

1. A chip comprising antibodies raised against ACTH, glucocorticoid receptor, CRHR-1/2, POMC, prolactin, arginine vasopressin receptor V1a, superoxide dismutase 1, superoxide dismutase 2, peroxiredoxin-3, CCR5, iNOS, eNOS, heme oxygenase-2, cyclooxygenase-2, HSP27, HSP40, HSP60, HSP70, HSP70i, HSP90, HSP110, GRP78/BIP, AIF, annexin II, annexin IV, caspase 1, caspase 2, caspase 3, caspase 6, cytokeratin, E-cadherin and GAPDH, with each respective antibody being printed on the chip at a specific discrete location on the chip.

2. A method for analysing stress levels in an animal comprising:
providing a sample from an animal suspected of being under stress; and
determining a stress profile for said animal by determining expression of one or more stress-related proteins.

3. The method according to claim 2 wherein the stress profile is determined using a chip comprising one or more antibodies against said stress-related proteins.

4. The method according to claim 3 wherein the stress-related proteins are selected from the group consisting of: ACTH, glucocorticoid receptor, CRHR-1/2, POMC, prolactin, arginine vasopressin receptor V1a, superoxide dismutase 1, superoxide dismutase 2, peroxiredoxin-3, CCR5, iNOS, eNOS, heme oxygenase-2, cyclooxygenase-2, HSP27, HSP40, HSP60, HSP70, HSP70i, HSP90, HSP110, GRP78/BIP, AIF, annexin II, annexin IV, caspase 1, caspase 2, caspase 3, caspase 6, cytokeratin, E-cadherin, GAPDH and mixtures thereof.
